(19) United States
(12) Patent Application Publication
(10) Pub. No.: US 2001/0013709 A1
(43) Pub. Date: Aug. 16, 2001

(54) HIDDEN STORAGE FOR VEHICLES

(76) Inventors: SCOTT CLARE, HAYWARD, CA (US); NEIL G. LONG, HAYWARD, CA (US)

Correspondence Address: L. E. CARNAHAN, PATENT AGENT, 4539 S. 1800 WEST #115, ROY, UT, 84067, US

(21) Appl. No.: 09/082,281

(22) Filed: May 20, 1998

Related U.S. Application Data
(63) Continuation-in-part of application No. 08/910,516, filed on Aug. 2, 1997, now Pat. No. 5,823,598.
Application No. 08/910,516 is a continuation-in-part of application No. 08/685,678, filed on Jul. 24, 1996, now abandoned.
Application No. 08/685,678 is a continuation-in-part of application No. 08/506,893, filed on Jul. 26, 1995, now Pat. No. 5,567,000.

(51) Int. Cl. B60R 11/00; B62D 33/02

(52) U.S. Cl. 296/37.6; 296/183

(57) ABSTRACT

A hidden storage for vehicles such as pickups, trucks, vans and utility/sports, utility and emergency vehicles without altering the external appearance of the vehicle. The hidden storage is located adjacent one or both sides of the vehicle between a rearmost side door and the rear of the vehicle or in the vehicle bed. The hidden storage is accessible only via one or more hinged side panel sections of the vehicle, and access to the interior of the vehicle does not provide access to the hidden storage area. The hidden storage is provided by a storage box secured to the side of the vehicle and the interior of the storage box is only accessible through opening of an associated hinged section of the side panel of the vehicle, which can be locked shut.

### RELATED APPLICATION

This application is a Continuation-In-Part of U.S. application Ser. No. 08/910,516 filed Aug. 2, 1997, which is a Continuation-In-Part of U.S. application Ser. No. 08/685,678 filed Jul. 24, 1996, now abandoned, which is a Continuation-In-Part of U.S. application Ser. No. 08/506,893 filed Jul. 26, 1995, now U.S. Pat. No. 5,567,000 issued Oct. 22, 1996.

### BACKGROUND OF THE INVENTION

The present invention relates to storage systems for vehicles, particularly to hidden storage for vehicles having side panels, while maintaining the external appearance thereof, and more particularly to hidden storage for pickups, emergency vehicles, vans, utility and sports utility vehicles without substantially altering the external appearance of the vehicle.

Various types of storage/utility systems have been utilized in various types of vehicles, primarily pickups, trucks, and trailers for transporting and/or storing tools, materials, etc. These prior utility beds for pickup trucks are exemplified by U.S. Pat. No. 3,245,713, No. 3,727,971, No. 4,685,695, and No. 5,615,922, all of which have hinged sections exposed to view. Also U.S. Pat. No. 1,990,757 teaches hinging a rear quarter panel to provide access to a compartment but does teach how the panel is hinged. In addition, recently issued U.S. Design Pat. No. 385,224 teaches a utility bed for a pickup wherein the side panels have been widened to cover the wheel wells to provide storage space and includes a compartment above the wheel well and compartments forward and aft of the wheel well, with each compartment having an exposed latch mechanism. Recently a hidden storage/utility system has been developed wherein the external appearance or contour of the vehicle has not been changed when compared to the same vehicle without a storage system therein, and the carrying capacity has not been significantly reduced. This hidden storage/utility system for pickup and truck beds and trailers is described and claimed in above-referenced U.S. Pat. No. 5,567,000. Also, above-referenced copending application Ser. No. 08/910,516 filed Aug. 2, 1997 entitled Hidden Storage For Vehicles describes and claims hidden storage systems for vans, utility and sports utility vehicles as well as modifications of the hidden storage arrangement of U.S. Pat. No. 5,567,000. Fabrication of the hidden storage system may be carried out, for example, as described and claimed in copending application Ser. No. 08/936,471, filed Sep. 22, 1997, which is an FWC of above-referenced application Ser. No. 08/685,678.

The hidden storage system of U.S. Pat. No. 5,567,000, for example, basically involved providing storage adjacent the wheel well area along part or the entire length of the bed, and providing, for example, the fender/side panel of the bed with a hinge and lock/latch arrangement, whereby the fender/side panel can be raised to expose the storage area, or closed and latched to conceal the storage area. In the closed position the external appearance is substantially the same as an identical vehicle without the hidden storage capability. Thus, by use of the hidden storage system, the vehicle can be parked in areas where theft would likely occur from conventional storage systems.

Like pickups, trucks and trailers, there is small to no hidden storage in emergency vehicles, vans, utility vehicles, and sports utility vehicles. Any hidden storage in such vehicles is in the interior thereof and access to the interior provides access to the hidden storage areas. Thus, theft from such vehicles is carried out by merely obtaining access to the interior thereof. To prevent potential theft, valuables must be removed from the vehicle and/or expensive alarm systems must be added. Thus, there has been a need for safe, readily accessible hidden storage in emergency vehicles, vans and utility/sports vehicles.

This need for hidden storage for such vehicles has been resolved by the present invention which involves an extension of the hidden storage system of the above-referenced patent and copending application Ser. No. 08/910,516 by applying the principles of that hidden storage system to emergency vehicles, vans, utility vehicles and sports utility vehicles, wherein side panel sections of the vehicle are hinged and provided with storage areas which are accessible upon outward movement (upward, downward or sidewise) of the hinged side panel sections. In addition to the interior of the emergency vehicle, van, utility and/or sports utility vehicles, which provide storage but the storage is readily accessible to theft, the present invention provides hidden storage (a trunk) for such vehicles with minimum altering of the external appearance of the side panels of the vehicle, and which is readily accessible to the owner but not readily accessible to theft. The hidden storage system of this invention can be fabricated via a conversion method, a modular assembly method, or an assembly line method.

### SUMMARY OF THE INVENTION

It is the object of the invention to provide hidden storage for vehicles without noticeable alteration of the external appearance of the vehicles.

A further object of the invention is to provide hidden storage for pickups, emergency vehicles, vans, utility vehicles and sports utility vehicles.

A further object of the invention is to provide hidden storage for vehicles utilizing hinged and latched sections of the fender/side panels of the vehicles.

Another object of the invention is to provide a van, utility vehicle, sports utility vehicle or emergency vehicle with safe, readily accessible hidden storage that is not accessible by mere access to the interior of the van or emergency/utility/sports vehicle.

Another object of the invention is to provide a vehicle with a hidden storage area along at least one side of the vehicle, that is accessible only by outward movement of at least one hinged section of a side panel or fender/side panel of the vehicle, without altering the normal external appearance of the vehicle.

Another object of the invention is to provide hidden storage for a truck, van, emergency, utility or sports utility vehicle which may, for example, extend along the entire length or along a partial length of the vehicle from a door to the rear of the vehicle, and which is accessible only via one or more hinged and latched sections of the side panel or fender/side panel of the vehicle; with only minor modification of the external appearance of the vehicle.

Other objects and advantages of the present invention will become apparent from the following description and accompanying drawings. Basically, the invention involves providing hidden storage for vehicles, particularly for trucks, vans, emergency, utility and sports utility vehicles, with only minor alteration of the normal external appearance of the vehicle. The minor alteration of the normal external appearance involves only thin vertical and/or horizontal lines in the side panels or fender/side panels which define the edge or edges of the hinged side panel sections, the hinges for the side panel sections being hidden with a latch/lock arrangement being hidden and accessible from the rear interior, for example, of the vehicle or by electrical control from a key or keyless control in the vehicle, whereby the lock of the latch/lock arrangement may be located anywhere on or in the vehicle. Due to the width of a normal vehicle side panel or fender/side panel, which consists of an outer and an inner panel, removal of the inner panel, hinging of the outer panel, and positioning of a narrow storage box having its only opening adjacent the removed inner panel provides adequate storage space for long items such as snow or water skis, ski poles, surf board, rifles, etc., as well as for storage of emergency type supplies, etc., as well as for camping/sports equipment or for materials or tools utilized in various trades. The narrow storage box, which may be as wide as the wheel wells of the vehicle, or narrower, results in only a small loss of interior space along the interior of one or both sides of the vehicle. By way of example, using a conventional van having only a driver door on the left side of the van, the hidden storage could extend from adjacent the driver's door to the rear of the van, the storage box being configured, for example, to conform to the floor and any wheel well area of the van, or can be located above the wheel well, if desired. With the storage box welded or otherwise secured to the side of the van, the only access to the interior of the storage box is via one or more hinged portions of the outer panel section of the side panel or fender/side panel, depending on the external configuration of the vehicle. By use of hidden hinges and hidden latch mechanisms which are commercially available and capable of withstanding 1,500 pounds pry pressure and controlled by conventionally available lock systems, the only changes in the exterior appearance of the side panel of the vehicle are the narrow lines along the vertical and/or horizontal edges of the hinged side panel section or sections. The hinged side panel sections are provided on the interior surfaces with sufficient support members and with insulation/sound absorbing materials. The opening or openings in the side panels are provided with seals similar to car trunk lid seals, such that when the hinged side panel sections are closed, water/dust cannot enter the hidden storage area. Recently, anti-frost seals have been developed for vehicles operating in extremely cold climates, as exemplified by copending U.S. application Ser. No. 09/(SC-3), filed ______, 1998, and entitled “Vehicle Compartment Seals”.

The hidden storage arrangement provided by this invention enables numerous types of vehicles to be built or modified to include one or more hidden storage compartments which are accessible only via one or more hinged side panel sections of the vehicle, and with the hinged side panel(s) closed, the storage compartments are not easily identified because of the minor modification in the exterior surface of the vehicle and have no exposed lock/latch mechanisms. The hidden storage can be incorporated into a vehicle by conventional assembly line techniques, modular fabrication and assembly, or conversion or retrofitting an existing vehicle.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIGS. 1 and 2 illustrate a side view and plan view of a bed of a hidden storage system of a pickup truck generally similar to that described and illustrated in above-referenced U.S. Pat. No. 5,567,000.

FIGS. 3 and 4 are rear views of vehicles, such as shown in FIGS. 6 and 7, with a hidden storage system on each side, and with strut assemblies to hold the hinged side panel sections in a raised or open position.

FIG. 5 is a perspective view of a hidden storage system in a van in accordance with the present invention.

FIG. 6 is a side view of a four-door utility vehicle with a hidden storage system in accordance with the present invention.

FIG. 7 is a side view of a two-door sports utility vehicle with a hidden storage system incorporated therein according to the present invention.

FIG. 8 is a side view of a pickup bed having three hinged side panel sections, with one hinged section including the tail light assembly.

FIGS. 9-12 schematically illustrate various modifications of side panel and storage box arrangements of the hidden storage system of FIGS. 1-2, 5-8 and 24-26.

FIGS. 13 and 14 schematically illustrate mechanical and electrical latch/lock arrangements for the hinged side panels.

FIGS. 15 and 16 illustrate embodiments of struts for the hinged side panels with FIG. 15 having an insulated liner, while FIG. 18 includes a heater unit.

FIG. 17 schematically illustrates a shelving/storage arrangement for the storage box of the vehicles of FIGS. 1-2, 5-8 and 24/26.

FIG. 18 illustrates an adjustable and/or slideable shelving arrangement for the storage box of the vehicle.

FIG. 19 illustrates an embodiment of a drain/air relief valve assembly for the storage box of the hidden storage system.

FIG. 20 is a top view of a pickup bed illustrating by phantom lines a collapsible beam support assembly located beneath the bed.

FIG. 21 is an exploded view of the pickup bed of FIG. 20 illustrating openings in the side panels of the bed into which the collapsible beams of the support assembly extend, and in which a hidden storage system is mounted.

FIG. 22 is a cross-sectional view of a embodiment of an electrically heated seal assembly adapted to be mounted adjacent the periphery of each hinged side panel section of the hidden storage system such as illustrated in any of FIGS. 1-8 and 24-27.

FIG. 23 schematically illustrates a heated seal assembly, such as illustrated in FIG. 22, connected to a control/power source therefor.

FIG. 24 illustrates a side view of an emergency vehicle with a hidden storage system mounted therein and above the wheel well.

FIG. 25 illustrates a side view of a commercial or large van with a hidden storage system mounted therein and with the hinged side panel located above the wheel well and extending from the driver's side door to the rear end and including the tail light assembly.

FIG. 26 illustrates a side view of a vehicle similar to the FIG. 5 embodiment, but wherein the lower edge of the hinged side panel section is located above a decorative strip which extends along the lower edge of the side panel and wheel well.

FIG. 27 is a side view of a pickup bed hidden storage system wherein the hinged side panel includes the tail light assembly and wherein covered bins are located forward and rearward of the wheel well.

FIG. 28 illustrates another embodiment of a heated seal using a reflective member adjacent a heating element.

### DETAILED DESCRIPTION OF THE INVENTION

The present invention is directed to hidden storage for vehicles, such as pickups, trucks, vans and emergency/utility/sports utility vehicles, without substantially altering the external appearance of the vehicle. The hidden storage for vehicles as provided by the present intention basically involves providing the vehicle with one or more storage boxes located adjacent one or more side panels or fender/side panels of the vehicle, hinging at least one section of the one or more side panels or fender/side panels, whereby the hinged section can be opened to expose the interior of the storage box, and providing latch/lock mechanisms for the hinged side panel sections. The only alterations of the external appearance of the vehicle, with the exception of FIG. 8, are the narrow vertical and/or horizontal cuts defining the edges of the hinged side panel section or sections, the hinges and latch mechanisms being hidden from an external view of the vehicle except for an optional key slot.

Vans, both passenger and commercial, as well as emergency vehicles, utility vehicles and sports utility vehicles, are widely utilized in various fields of work, play and vacations. A common problem, as pointed out above, with vans and emergency/utility/sports utility vehicles is a lack of hidden storage space (no trunks). Once access to the interior of such a vehicle is made, one also has access to any hidden storage areas therein.

In recent years utility vehicles, such as the Suburban made by General Motors Corporation, sports utility vehicles such as the Bronco or Explorer made by Ford Motor Company and vans (both mini and full size) such as the Caravan made by Chrysler Corporation, have been popular vehicles for both work and personal use. Also, emergency vehicles, both of the van type and the truck type (cab and bed) regardless of size, have no hidden (trunk type) storage, and access to the interior thereof enables one to any medical supplies or equipment, drugs, etc. which may need to be carried in emergency vehicles. Hereafter the term vehicle is intended to include all such vehicles, and the term side panel includes all contoured or straight non-contoured sides of such vehicles with or without fender sections. Many of these vehicles are equipped with four wheel drive and thus are widely used for camping, ski outings and emergency applications. However, a drawback of these vehicles is a lack of storage space, particularly, for example, when families of four to six people travel. As a result on ski outings, for example, the skis, ski poles, etc. are mounted on the top of the vehicle and are thus exposed to the environment and theft. If, for example, skis, etc. are to remain with the vehicle overnight, safety and security requires that the skis, etc. be removed from the top of the vehicle and placed inside the vehicle. Many emergency type vehicles need to carry equipment which takes up considerable interior space as well as medical supplies, etc. which are accessible to theft. Mere breakage of a window in a vehicle, for example, enables access to the interior thereof and theft of the skis, other equipment, etc. in the vehicle.

By incorporation of the present invention into such vehicles, skis, ski poles, etc., or water skis, surf boards, emergency equipment supplies, etc., for example, may be safely stored in the vehicle, and thus one gaining access to the interior of the vehicle does not have access to the storage area. Access to the storage area is only through a hinged/locked side panel section of the vehicle. Most vehicles of the type considered herein have sufficient length between a door and the rear of the vehicle to enable incorporation of the hidden storage area without adversely affecting the interior space of the vehicle. Also, by the elimination of exposed lock/latch mechanisms, the storage compartments are not readily recognized by those inclined toward theft. While the addition of a key slot for the hinged side panel sections has been shown, such would reduce the hidden advantages of the storage system, and increase the potential for theft therefrom. Thus, while the hidden storage/utility system of the above-referenced U.S. Pat. No. 5,567,000 provides a “truck-with-a-trunk” for a vehicle bed, the present invention provides vans and emergency/utility/sports utility vehicles with a trunk, a hidden storage area, with only minor alterations to the external appearance appearance thereof. Note that as shown in FIG. 2, the side panels 15 include a fender 28. The hidden storage also serves to provide means to remove and store unrestrained articles from inside the vehicle, thereby improving passenger safety. The hidden storage may be incorporated above the wheel well, or forward of, rearward of, and above the wheel well, or combinations thereof.

The hidden storage system of the present invention may be fabricated from various materials including metals, fiberglass, reinforced plastics, and combinations thereof, as these various materials are now commonly utilized for various components in vehicle manufacturing.

The hidden storage may be incorporated by various methods, such as by an assembly line method or a conversion (retrofit) method similar to the techniques described and claimed in above-referenced copending application Ser. No. 08/936,471. Also, the components for the hidden storage system may be fabricated and/or assembled using a modular method similar to the technique described and claimed in copending U.S. application Ser. No. 08/896,388, filed Jul. 18, 1997, entitled “Hidden Storage/Utility System Modular Fabrication Method”.

While the invention is illustrated and described hereinafter for a pickup, van, emergency or utility vehicle, it can be incorporated into most vehicles of the type described above, it being recognized that vehicles having two doors on each side rather than a single door leaves less length between the rear door and the rear of the vehicle, and thus less space for hidden storage. Also, vehicles designed for the carrying of passengers, which include windows along the side, provide less space for incorporation of the hidden storage system than similar vehicles not designed for passenger use.

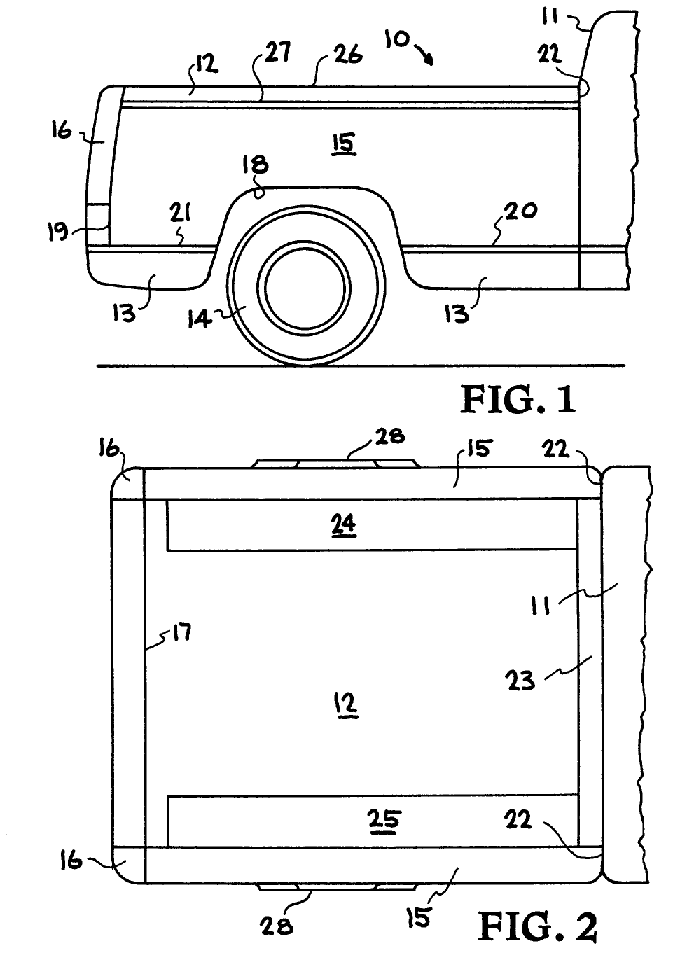

In view of the extension of the hidden storage/utility system of above-referenced U.S. Pat. No. 5,567,000 to vans and emergency/utility/sports utility vehicles, again referred to hereinafter generically as vehicles. FIGS. 1 and 2 illustrate side and plan view of the hidden storage system incorporated into a bed of a pickup truck. As seen in FIG. 1, from a side view, the only alteration to the normal exterior side panel appearance is the single vertical line or cut indicating the rear edge of the hinged side panel, the front edge of the hinged side panel extending to the front of the bed. In later configurations, the tail light section is incorporated into the hinged side panel. The hinge for each side panel is located on an inner area of the side panel along the upper section thereof so as not to be exposed to one viewing the bed from an external side position. Thus, one would not readily recognize the modification of the bed, and therefore those with intent to steal tools, etc. from the vehicle would not recognize the hidden storage arrangement.

Referring now to the drawings, FIGS. 1 and 2 illustrate a conventionally appearing pickup truck generally indicated at 10 having a cab 11, bed 12, frame or undercarriage 13 and includes hinged side panels 15, a tail light arrangement 16, a hinged tail gate 17 and wheel wells 18. However, the bed 12 of FIGS. 1 and 2 has been modified in accordance with the present invention, with the only indication of such modification being the cut, small space, or lines 19 in the side panels 15 below tail light 16, as shown in FIG. 1, with the side panel being closed. Note that in this embodiment the hinged side panels 15 terminate adjacent sections of the side panel secured to the frame or undercarriage 13 as indicated by the lines 20 and 21, and the front edges of the hinged bed side panels are indicated at 22, where the side panels 15 contact a front panel or bulkhead 23 of the bed 12.

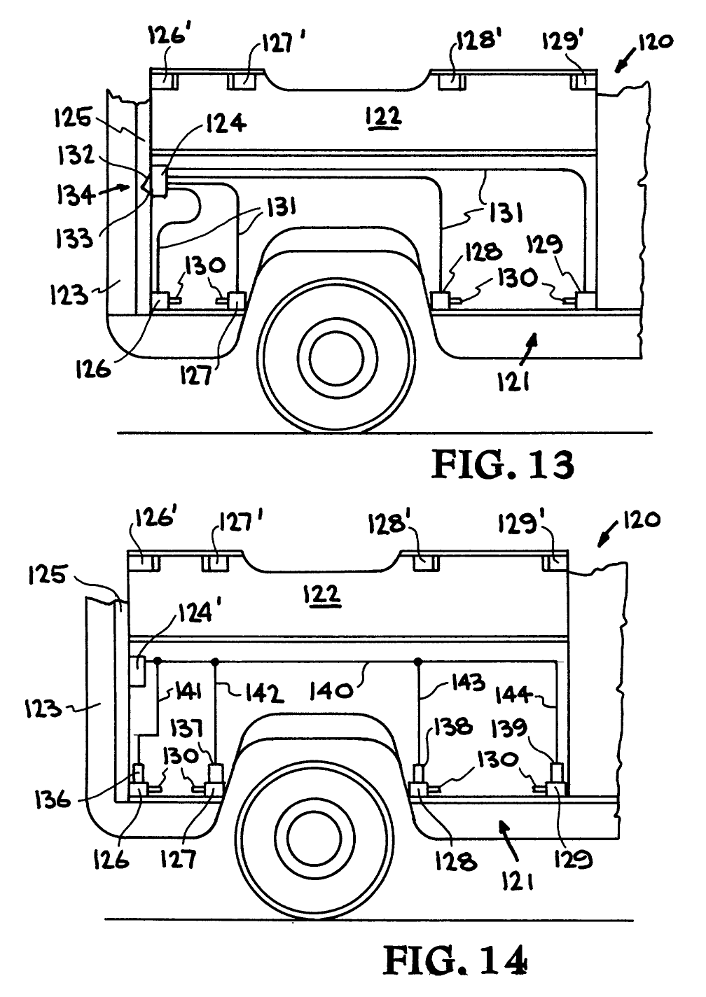

As seen in FIG. 2, the hidden storage area is provided by storage or structure boxes 24 and 25 mounted within the bed 12 and forward, rearward and over the wheel wells 18, the boxes 24 and 25 being constructed to cover the wheel wells 18, but not extend to the top or upper surface 26 of bed 12 so as not to be seen from an external view, and terminate in spaced relation to tail gate 17. The top of the storage boxes extend along the bed at a height equal to line 27 in FIG. 1. Side panels 15 include a fender section 28. A lock mechanism is mounted in the rear of each of boxes 24 and 25 and activates latch mechanisms which include latch members located in spaced relation along the bed 12, and which cooperate with corresponding latch members in side panel 15, as shown in FIGS. 13 and 14. As seen in FIG. 13, the latch members are interconnected by a cable which is connected to the lock mechanism, or are connected electrically as shown in FIG. 14.

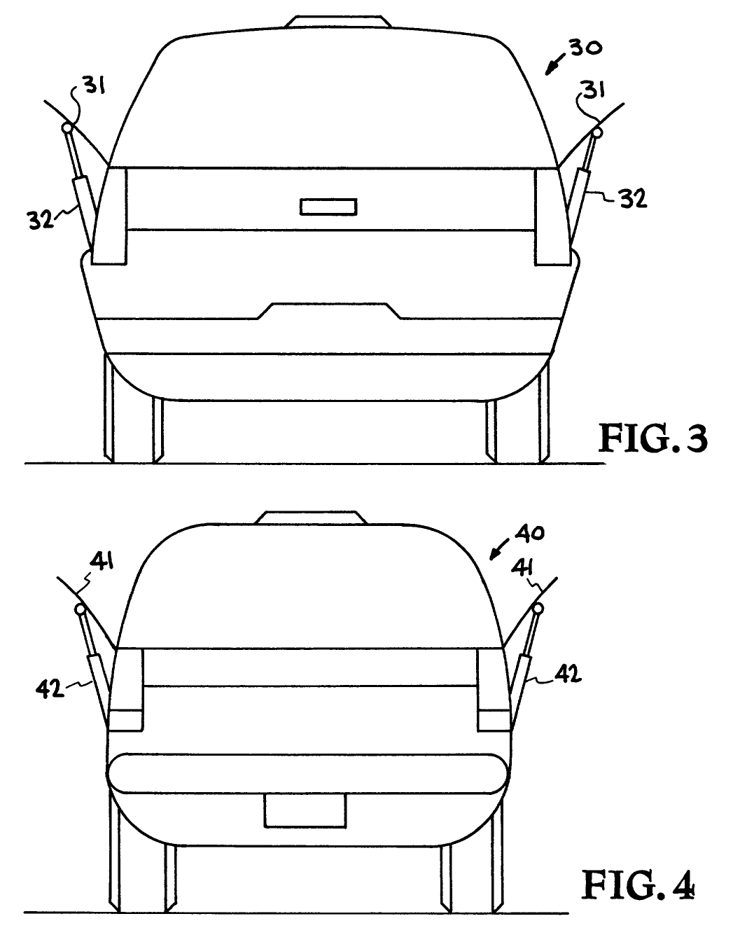

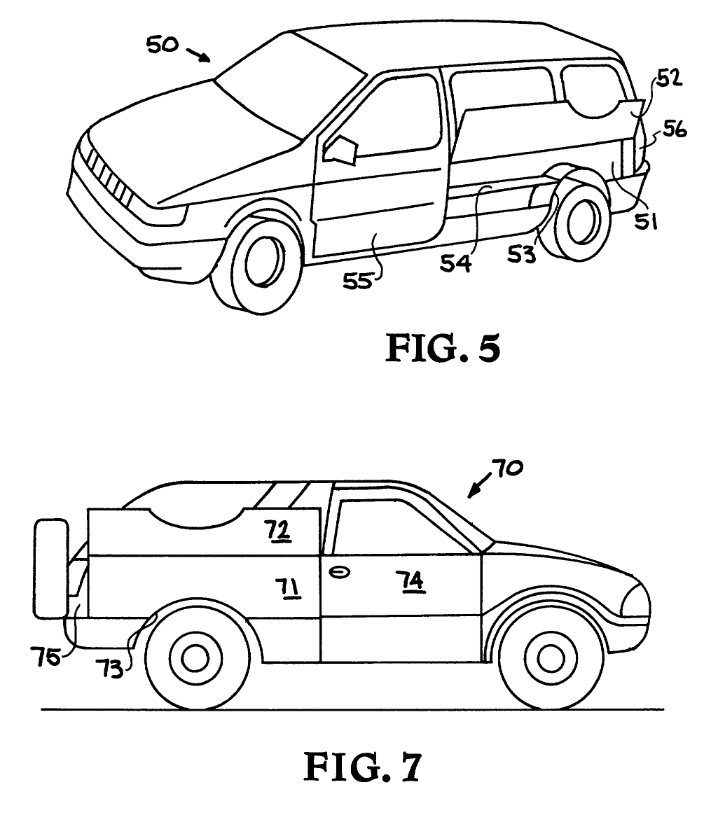

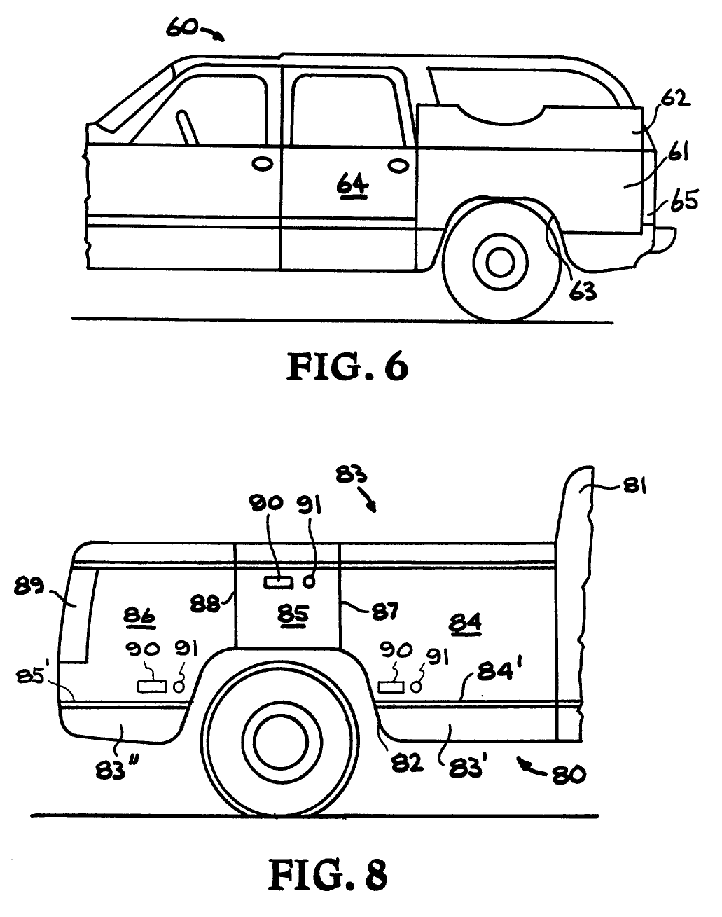

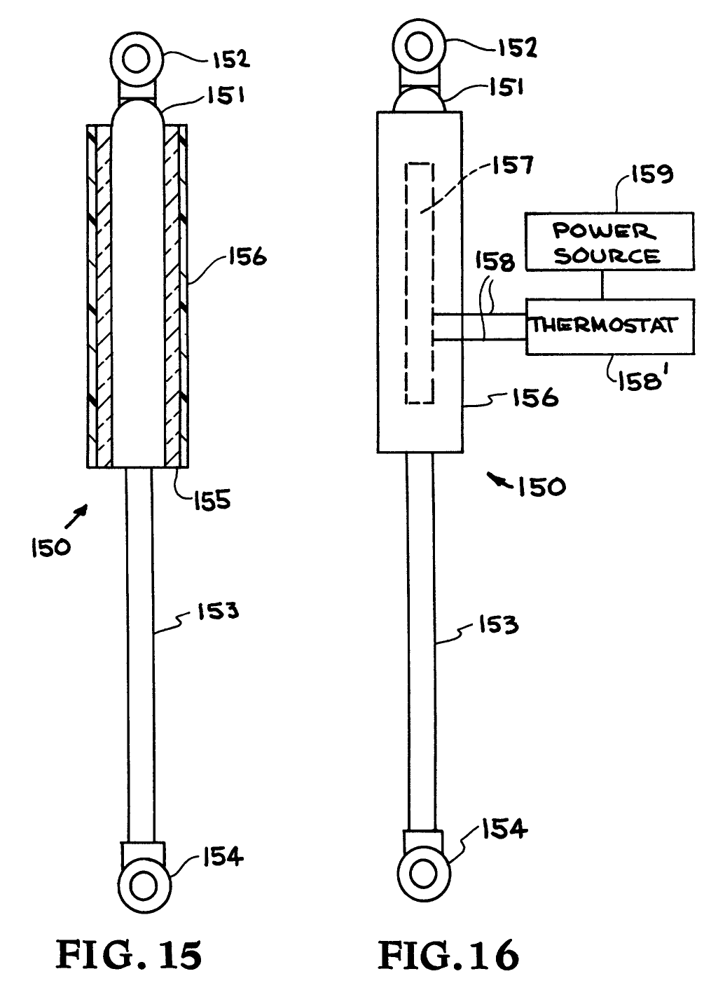

FIGS. 3 and 4 illustrate rear views of two different vehicles, such as the utility and sports utility vehicles described hereafter with respect to FIGS. 6 or 7, and illustrate hinged side panel sections on each side of the vehicle, since each of the vehicles of FIGS. 5-7 may be provided with a hidden storage system on each side thereof. As shown, the vehicles indicated at 30 and 40 include hinged side panel sections 31 and 41 adapted to close or open the interior of a storage box located on each side of the vehicle. The hinged side panel sections 31 and 41 are held in an open position by one or more strut assemblies 32 and 42 on each side of vehicle 30 and 40. The strut assemblies 32 and 42 may be of the type described with respect to FIGS. 15 and 16 and nay be insulated, heated or insulated and heated, depending on the environmental conditions of the location of the vehicle.

FIG. 5 illustrates a van, such as a conventional three-door van, with a hidden storage system incorporated on the left or drivers side. While the van is illustrated as a passenger type, having windows along the side, and generally having a third door on the opposite or passenger side and a rear door, the hidden storage system can be incorporated into commercial type vans of various types, which may not include windows on the sides and may include only two doors plus a rear door. The interior of the van incorporating the hidden storage includes a storage box which extends along the interior side of the van adjacent the hinged side panel sections as in FIGS. 1-2 embodiment, the width and height of the storage box being varied in accordance with various needs.

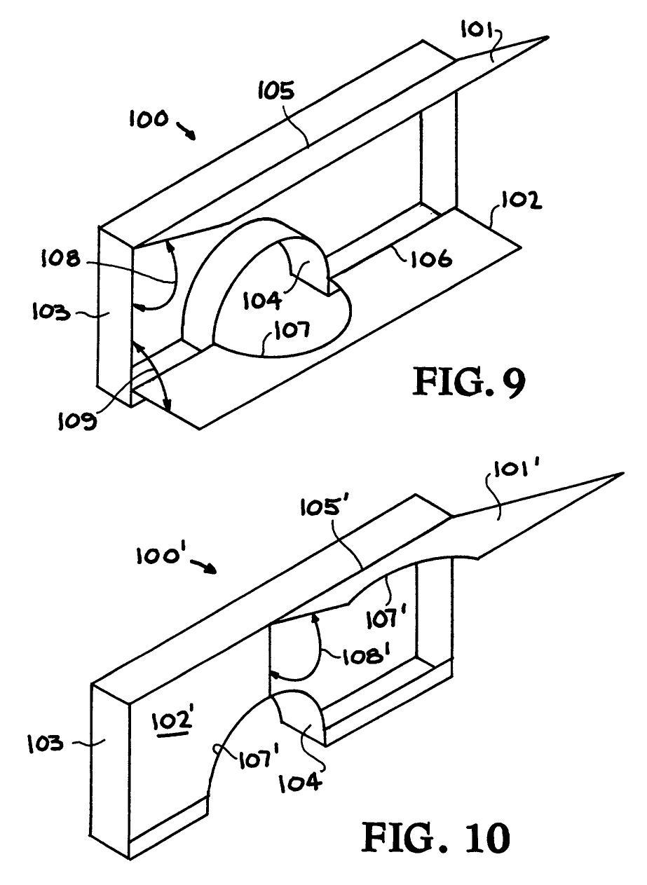

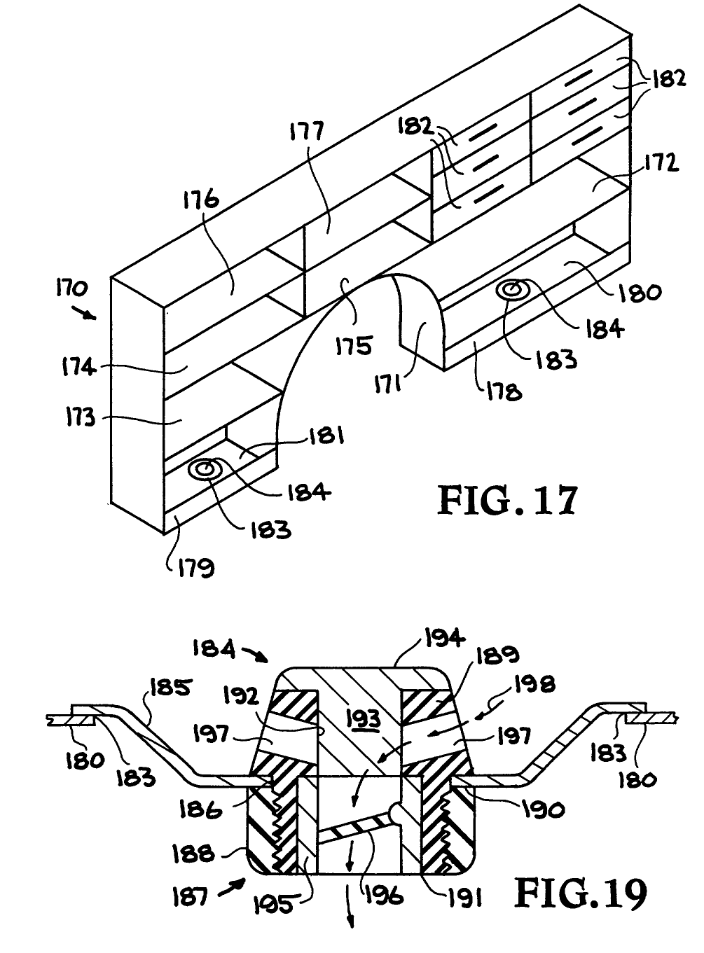

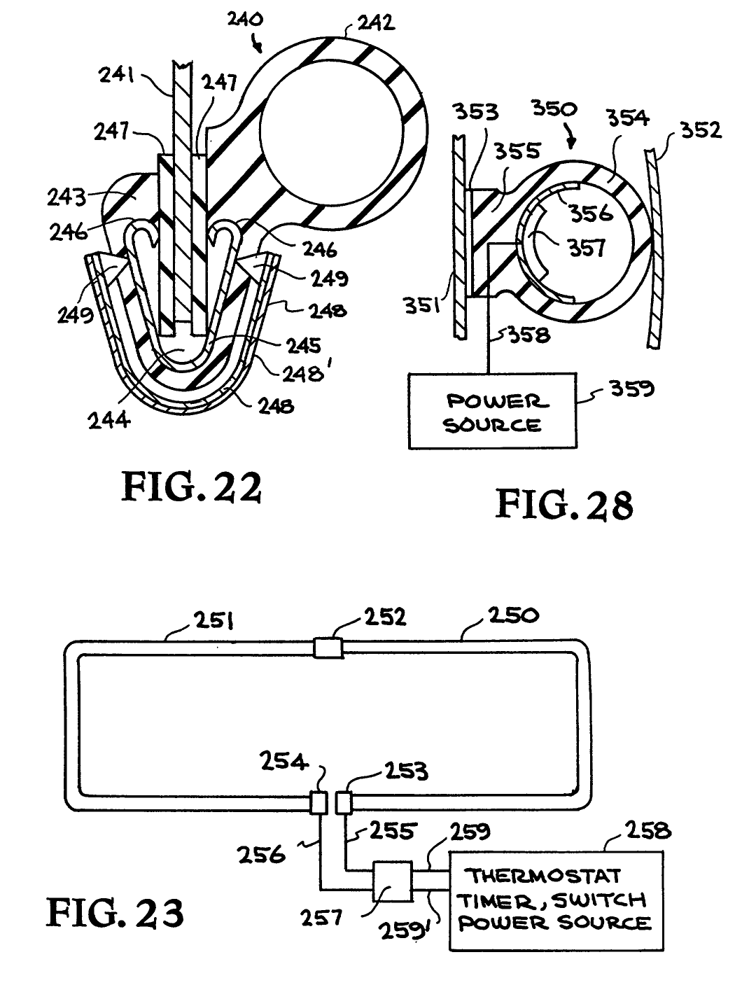

As shown in FIG. 5, the van generally indicated at 50, such as a Dodge Caravan, is either initially assembled or modified (retrofitted) to include a storage box 51 and a hinged side panel section 52, with the storage box 51 and side panel section 52 being configured to extend over a rear wheel well 53 of van 50. The storage box 51 is provided with at least one shelf as shown at 54, which may be of an adjustable type and/or slideable type. A seal assembly is utilized to seal out moisture and/or dust when the side panel section is closed, and the side panel section includes support members as in the embodiment of FIGS. 1-2. In FIG. 5, the storage box 51 and hinged side panel section 52 extend from a point behind the driver's side door 55 to a point ahead of the rear 56 of van 50, and the side panel section 52 is hinged to raise upwardly. However, as described and illustrated hereafter with respect to FIGS. 9-12, the hinged side panel section(s) and/or storage box(s) may be located along only portions of the vehicle's side and/or may be split or hinged downwardly, sidewise, and/or upwardly. The hinges need not extend along the entire length of the hinged side panel section. Also, as illustrated with respect to the FIGS. 1-2 embodiment, and described hereinafter and illustrated in greater detail with respect to the FIGS. 13-14 embodiments, the hinged side panel section of FIG. 5 is provided with a lock/latch mechanism of either a mechanical or electrical type. Also, as seen in FIGS. 3 and 4 and described hereinafter in greater detail with respect to FIGS. 15-16, the hinged side panel section of FIG. 5 is provided with a strut assembly to retain the side panel section in open position. In addition, the shelving arrangements of FIGS. 17 and/or 18 may be utilized in the FIG. 5 embodiment. While not shown, an appropriate seal, such as illustrated in FIGS. 22-23 and 28, may extend around the opening in the side panel, similar to a trunk seal, such seal assemblies described and claimed in copending application Ser. No. 09/(SC-3) filed ______, 1998 and entitled “Vehicle Compartment Seals”.

FIG. 6 illustrates a four-door utility vehicle, such as a Chevy Suburban, with a hidden storage system incorporated between the rear side door and the rear of the vehicle. The utility vehicle indicated at 60 includes a storage box 61 and a hinged side panel section 62, which are constructed to extend over a wheel well 63 intermediate rear side door 64 and the rear end 65 of the vehicle, as described above. While no shelving is shown in FIG. 6, one or more shelves of different types, such as shown in FIGS. 17 and 18, for example, may be installed in the interior of storage box 61. The hinged side panel sections may be in various configurations as described hereinafter with respect to FIGS. 9-12. Also, as described above with respect to FIG. 5, lock/latch mechanisms and strut assemblies are incorporated to lock, release and retain the hinged side panel section 62. An appropriate moisture and dust seal is utilized about the edge of the hinged side panel section when closed, and the inner surface of the side panel section may be coated with insulation and/or sound absorbing materials. Also, appropriate structural supports are fixed to the inner surface of the hinged side panel section.

FIG. 7 illustrates the hidden storage system incorporated into a two door sports utility vehicle, such as a Ford Explorer, Chevy Blazer, etc. The vehicle indicated at 70 includes a storage box 71 and a hinged side panel section 72 which extend over a wheel well 73 and are located intermediate a passenger side door 74 and a rear end 75 of vehicle 70. As in the embodiments of FIGS. 5 and 6, the storage box and/or hinged side panel section includes shelves, insulation/sound materials, supports, a lock/latch mechanism, and strut assemblies. Also, as described above and in greater detail with respect to FIGS. 9-12 and 17-18, various configurations of the storage box and/or hinged side panel sections and shelving arrangements may be utilized.

FIG. 8 illustrates an embodiment of a pickup bed similar to FIGS. 1 and 2, with a hidden storage system mounted in the side panels thereof, but with three hinged side panel sections, and wherein the tail light assembly moves with the rearmost hinged side panel section. The bed indicated generally at 80 is mounted on a frame, not shown, connected to a cab 81, and includes wheel wells, only one shown, at 82. The storage system of FIG. 8, while not shown, includes a storage box as in FIGS. 1-2 and a lock/latch mechanism, as shown in FIGS. 13-14. The bed 80 includes side panels generally indicated at 83 on each side, only one shown, and each or either of which include three hinged sections 84, 85 and 86, with hinged section 84 extending from the front edge of the side panel to an area above the wheel well 82 as indicated by vertical cut line 87, hinged section 85 being located above wheel well 82 and defined by cut line 87 and another vertical cut line 88, with hinged section 86 extending from cut line 88 to the rear end of bed 80 and including tail light assembly 89. Each of hinged sections 84 and 86 may be hinged horizontally or vertically so as to open upwardly, downwardly, or sideways, and may terminate along lines 84′ and 85′ or extend to the bottom of side panel sections 83′ and 83″. Hinged section 85 is hinged horizontally and thus can be either raised or lowered. If section 85 is hinged at a lower end, it can be designed on the inner surface thereof to provide a work bench, and if hinged at the upper end, one or more slideable compartments or shelves, as described hereinafter with respect to FIGS. 17 and 18 may be mounted behind the hinged section 85 of the side panel, or if desired, can be hinged to open downwardly with slideable shelves or compartments located therebehind. Also, if desired, the three hinged side panel section arrangement of FIG. 8 can be modified as described hereinafter with respect to FIGS. 9-12. While not shown, the storage box on each side of bed 80 may have a height equal to the height of the side panels 83, or may have a height less than the height of the side panels, as in the embodiment of FIGS. 1-2. Hinged sections 84, 85 and 86 may be optionally provided with a flush type handle latch or handle 90 and a key lock 91, but unexposed latch and lock means as shown in FIGS. 13 and 14 are preferred.

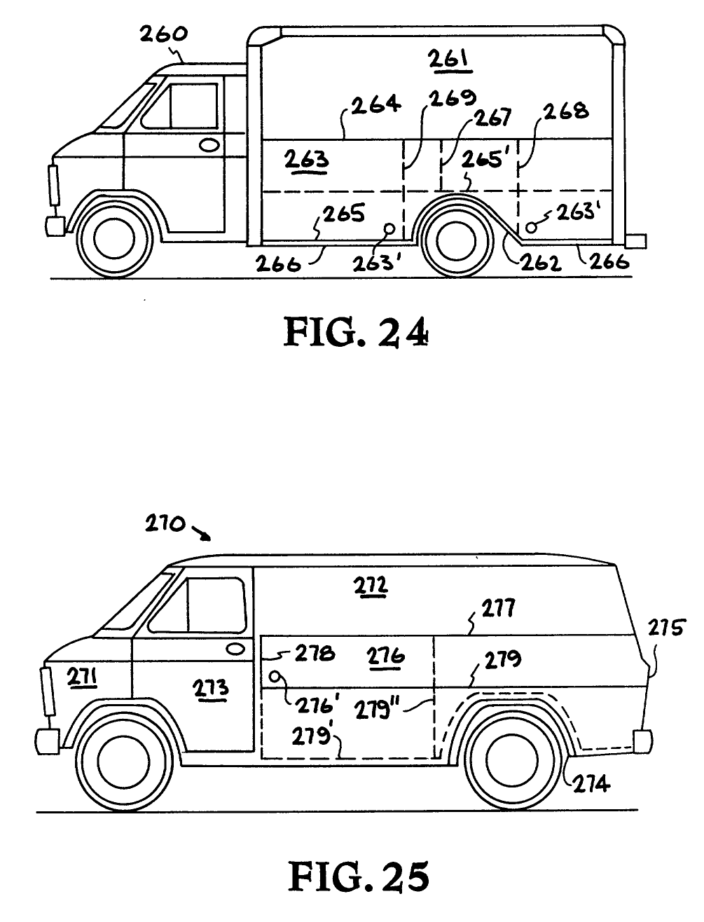

The vehicle, such as illustrated in FIGS. 1-7, 26 and 27, as well as the larger type vans and truck type emergency vehicles as illustrated in FIGS. 24 and 25 may include a plurality of hinged side panel sections which may open upwardly, downwardly or sideways, and one or more of hinged side panel sections may be constructed on the interior thereof to form a work bench when opened. Various hinged panel section arrangements utilizing the same storage box are schematically illustrated in FIGS. 9-12, and such can be utilized in any of the above-identified types of vehicles regardless of the size or type of body or bed. While not illustrated, the hinged side panels have the same external contour as that of a similar vehicle without the hidden storage system. In other words, the hinged side panel sections or hinged fender/side panel sections have a contour corresponding to the remainder of the vehicle's side panels or fender/side panels. Thus, the only external differences of the FIGS. 9-12 embodiments are the vertical and/or horizontal cut lines which define the edges of the hinged side panel sections. While not shown, the side panel sections may be hinged to open sideways. The hinges and lock/latch mechanisms, as pointed out above, are hidden from an external view of the side of the vehicle, with the exception of FIG. 8.

FIGS. 9-12 schematically illustrate modifications of the fender/side panels of the hidden storage system illustrated in FIGS. 1-8 and the vehicles of FIGS. 24-26, wherein there is no fender and/or the storage system is located above the fender (wheel well). It is to be understood that in actual practice the embodiments of FIGS. 9-12 would be configured as described above to match the external contour of the side panels or fender/side panels, and the storage boxes would be positioned within the vehicle or bed, as described above. Also, it is to be understood that a storage box could extend only along a section of the side panel which is hinged, and not the entire length of the side panel. In each of FIGS. 9-12, the storage box and wheel well are given the same reference numbers.

FIG. 9 illustrates a split side panel arrangement generally indicated at 100 wherein a pair of longitudinal extending panel sections forming an upper panel section 101 and a lower panel section 102 are hinged to a storage box 103 formed over a wheel well 104 as indicated along horizontal lines 105 and 106, with the lower panel section 102 being configured as indicated at 107 to cooperate with the wheel well 104. As indicated by arrows 108 and 109, the upper panel section 101 and the lower panel section 102 are hinged whereby section 101 is raised and section 102 is lowered. While not shown, the upper panel section 101 would be provided with restraining struts, and the lower panel section 102 with restraining type hinges, chains, etc. This arrangement provides at least three advantages: 1) the lower panel section 102 may be utilized as a work shelf or bench, and 2) in case of strong winds, for example, the upper panel section is smaller and thus easier raised and lowered; and 3) either the upper or lower panel section may be utilized without having to raise the entire side panel. Also, the upper and lower panel sections would be provided with hidden latch and lock mechanisms.

The FIG. 10 embodiment differs from the FIG. 9 embodiment in the configuration of the side panel sections with the storage box and wheel well being indicated at 103 and 104, as in FIG. 9, and corresponding reference numerals illustrate corresponding components. In this embodiment only one or both side panels can be hinged. In FIG. 10, the split side panel arrangement generally indicated at 100′ includes a pair of split side panel sections 101′ and 102′ which are hinged along horizontal lines 105′ and 106′ at the upper end thereof. The panel sections are configured to conform with the contour of a conventional side panel or fender/side panel vehicle contour. Side panel section 101′ is shown in the raised or open position as indicated by arrow 108′, while side panel section 102′ is in the lowered or closed position. In this embodiment, only side panel section 101′ may be hinged with the storage box 103 only extending the length of section 101′. In this embodiment, each of the side panel sections 101′ and 102′ include a section 107′ configured to cooperate with the wheel well 104 of storage box 103. While the side panels 101′ and 102′ are hinged to swing or open upwardly, they could be hinged along the lower ends, as side panel section 102 of FIG. 9, whereby they could be lowered when opened, or hinged such that one section opens upwardly and one section opens downwardly, or hinged vertically at the edges opposite the wheel wells 104 so that side panels 101′ and 102′ could swing sidewise. Also, only side panel section 101′, for example may be hinged. The advantages of the FIG. 10 embodiment is in the use of the storage area in front of the wheel well or in back of the wheel well, or both. Also, with only one section of the side panel open, there is less resistance to winds and can be easily opened and closed compared to the full side panel. While not shown, the side panel section 101′, and if hinged the side panel section 102′, would be provided with support or retention struts if opened upwardly or sideways, or with retaining means, similar to that of a conventional pickup tailgate, if hinged to open downwardly. A hidden latch and lock arrangement, while not shown, would be provided for the hinged panel section(s). Also, the side panel sections are configured to conform with the contour of the desired side panel of the vehicle.

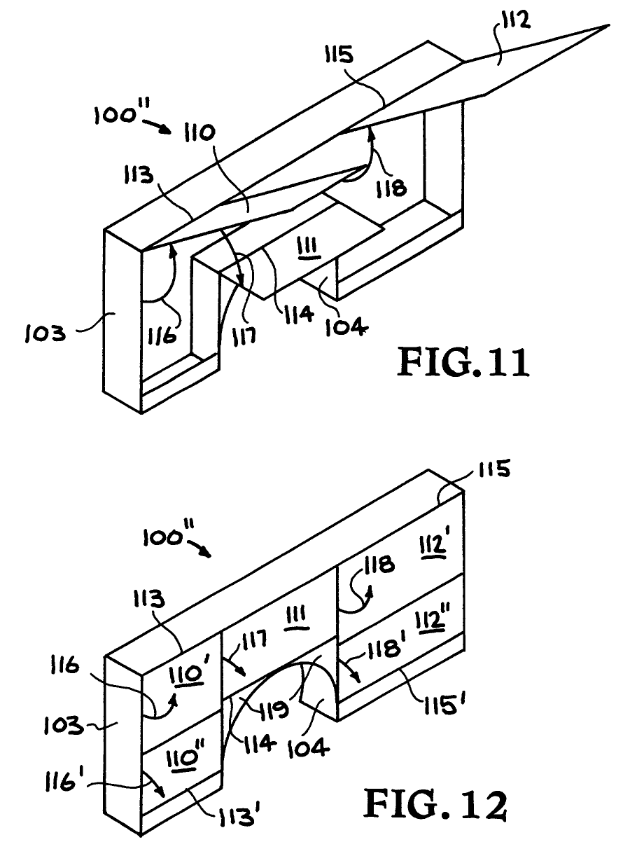

FIG. 11 illustrates another arrangement involving three movable side panel sections utilizing the sane storage box and wheel well arrangement of FIG. 9 and, where appropriate are given corresponding reference numerals. As shown, the three-way split side panel arrangement generally indicated at 100″ comprises a storage box 103 built over a wheel well 104, and provided with three (3) hinged side panel sections 110, 111 and 112 which are hinged along horizontal lines indicated at 113, 114 and 115 respectively. As indicated by arrows 116, 117 and 118, side panel sections 110 and 112 open upwardly while side panel section 111 opens downwardly. However, side panel section 111 may be hinged to open upwardly, and all three sections may be hinged on a common hinge. In addition, sections 110 and 111 may be hinged at a lower end so as to open downwardly, or hinged along either side so as to open sidewise. In this embodiment, the center side panel section 111 may be used as a work table, and any of the storage box sections above, in front of, or behind the wheel well may be utilized individually. If desired, only one or two of the three sections may be hinged and provided with a storage box therebehind, whereby storage would only be in one or two sections adjacent the wheel well.

FIG. 12 illustrates a modification of the FIG. 11 side panel arrangement and differs in utilizing five (5) side panel sections instead of three, with two of the sections being split. Components corresponding to those of FIG. 11 are given for corresponding reference numerals. The difference between FIG. 11 and FIG. 12 is that the two end sections 110 and 126 of the side panel of FIG. 11 are split in FIG. 12 as indicated at 110′-110″ and 112′-112″, with panel sections 110′ and 112′ opening upward and panel sections 110″ and 112″ opening downward as indicated by arrows 116-116′ and 118-118′, with lower panel sections 110″ and 112″ being hinged along lines 113′ and 115′. As in the FIG. 11 arrangement, the central side panel section 111 can be hinged to open upwardly instead of downwardly as shown. Also, where the side panel section 11 is hinged to open inwardly, the side panel areas indicated at 119 adjacent the wheel well 104 can be included with the side panel section 111. In this embodiment any or all of panel sections 110″, 111 and 112″ can be utilized as a work table or bench. Also, by the arrangement of FIG. 12, there is access to various sections of the storage box 103 without the need to expose the entire interior of the storage box. As described above, the individual side panel sections are each provided with a hidden latch/lock system and, if desired, the latch/lock system may be constructed to release individual or all of the side panel sections, either mechanically or electrically, as described below.

The side panel section arrangements of FIGS. 9-12 enable, if desired, the length and location of the storage box located behind the hinged sections to be varied. For example, with the FIG. 10 arrangement, the storage box need only extend half the length of the bed, providing side panel section 102′ was not hinged. Also, with the panel section arrangement of FIG. 9, the storage box may need only extend along the body so as to be located above the level of the wheel well, provided the lower side panel section 102 is not hinged. As readily seen from the arrangements of FIGS. 11 and 12, certain side panel sections need not be hinged and the storage box therebehind may be constructed only to extend the length or depth of the desired hinged side panel sections. Regardless of the side panel section arrangement a user may desire, the hinged side panels must conform to the contour of the overall side panel or fender/side panel configuration of the vehicle. It is recognized that the external appearance of the overall side panels of the body will show vertical or horizontal cuts defining the various side panel sections involved when sections of the side panels are hinged as illustrated in FIGS. 9-12. While it is preferable to hinge the side panel sections to open upwardly or downwardly, they can be hinged to open sideways. Also, in vehicles such as larger vans, illustrated in FIG. 25, and in the bed section of truck type emergency vehicles, such as illustrated in FIG. 24, the hinged side panel sections and associated storage boxes may be located above the wheel wells of the vehicle.

FIGS. 13 and 14 schematically illustrate embodiments of a mechanical type and an electrical type of latch/lock mechanism for a hidden storage system of a pickup bed, such as shown in FIGS. 1-2 and 8, but the latch/lock mechanism can be utilized in the hidden storage system of any of the vehicles of FIGS. 3-7 and 24-27. Since the latch/lock mechanism is not visible from an external view of the vehicle, such is considered to be a hidden mechanism and is so defined herein. In the embodiment of FIG. 13, the latch mechanism is cable actuated. As shown, a vehicle indicated at 120 containing a hidden storage system generally indicated at 121 which includes a storage box as above described, and which includes at least one hinged side panel 122, and provided with an end gate or rear door 123, includes a lock release mechanism generally indicated at 124, having a keyed or keyless lock, not shown, and located at the rear of the storage system and spaced as indicated at 125 from the rear door 123. By this arrangement, the lock release mechanism 124 can be actuated from the inside of the vehicle without opening the end gate or door 123. The latch mechanism constructed of cooperating components are indicated at 126-126′, 127-127′, 128-128′, and 129-129′, with components 126, 127, 128 and 129 secured to the vehicle 120 or storage box within the enclosed area, while cooperating components 126′, 127′, 128′ and 129′ are secured to the inner and lower edge of the hinged side panel 122, such that when the side panel 122 is lowered the components of the latch mechanism interconnect. The components 126-129 each include a movable release member 130, which is actuated by a cable 131 connecting the lock release mechanism 124 via a lever 132 of the lock mechanism 124. Thus, upon movement outwardly of over 132 as indicated by arrow 133, the lock mechanism 124. Thus, upon movement outwardly of lever 132 as indicated by arrow 133, the cable 131 activates the movable release member 130, where latch components 126′-129′ are released from components 126-129, and the hinged side panel 122 can be raised as illustrated. To re-secure the side panel 122 when lowered, the lever 132 of lock release mechanism 124 is moved inwardly as indicated by arrow 134 whereby the activation cables 131 and release member 130 enable latch mechanism components 126-129 and 126′-129′ to be reengaged for retaining the side panel 122 in a secured closed condition. Various types of mechanical lock/latch mechanisms are commercially available and thus a detailed description of a specific embodiment is deemed unnecessary. However, the lock/latch mechanism should be constructed to prevent the side panel 122 from being easily pried open. Some known lock/latch mechanisms require a 1500 pound pry to open same.

FIG. 14 illustrates an electrically activated lock/latch mechanism, and is constructed similar to that of FIG. 13 except that electric solenoids and electric leads replace the activation cables of FIG. 13 and the lock release mechanism requires only a push button or key to actuate the latch mechanism via the solenoids. Also, the lock mechanism may be remotely controlled, such as by well known vehicle security key/lock systems. As shown in FIG. 14, the lock release mechanism 124′ is located at the rear of the storage box and spaced from the end gate or rear door 123 as indicated at 125. Cooperating latch mechanisms 126-126′ 127-127′, 128-128′ and 129-129′ are mounted on bed 121 and side panel 122 as described above in FIG. 13. Each of latch mechanism components 126, 127, 128 and 129 are provided with a solenoid 136, 137, 138 and 139 which are connected to lock release mechanism 124′ via electrical leads 140, 141, 142, 143 and 144. To release the latch mechanism to enable opening of the side panel 122, the lock release mechanism 124′ is activated, such as by a push button, key, or combination, as known in the art, which activates solenoids 136-139 thereby moving movable members 130 to allow latch components 126′-129′ to be released from latch components 126-129, allowing side panel 122 to be opened. Since solenoid activated lock/latch mechanisms are well known in the automotive art, further description is deemed unnecessary.

While FIGS. 13 and 14 illustrate embodiments of the lock/latch mechanism with the lock release mechanism 124′ located at the rear of the storage box, the lock release mechanism can be located at the front of the storage box, or if an electrical lock/release system is used, as in FIG. 14, the lock release mechanism 124′ can be located in the glove box, behind the driver's seat, or elsewhere in the vehicle. If desired, a key actuated lock release mechanism can be installed in a hinged side panel section but such would be visible from an external vies of the vehicle and therefore would not be desirable in that the hidden aspect of the storage system would be reduced.

While the FIGS. 13-14 embodiments have illustrated the use of four (4) latch mechanisms, that number may be less for a single hinged side panel. Where the hinged side panel is composed of side panel sections, as in FIGS. 9-12, each hinged section should include one or more latch mechanisms, either mechanical or electrical. Also, where the side panel sections are hinged to open downwardly, the location of the cooperating latch mechanism components may be different and, for example, such may be secured to the sides of the hinged side panel sections and to a cooperating location on the storage box.

As pointed out above, the upwardly opening side panels are provided with means for retaining same in open position, such as by conventional torsion springs or strut assemblies, widely used in the automotive field for retaining open rear windows or doors. However, hinges which include spring or mechanically biased means, for example, are also commercially available which are constructed to retain a door or window open, and thus could be utilized in the hinged side panels, particularly those that are hinged to open downward or sideways. The use of strut assemblies is generally preferred for upwardly opening side panels, but struts have disadvantages when operating in extreme temperature conditions, either hot or cold. This problem is resolved by the strut assemblies illustrated in FIGS. 15 and 16, wherein insulation and/or heating therefor is provided. FIG. 15 illustrates a convention strut assembly with insulation about the body member, while FIG. 16 additionally illustrates an electrical heating strip for a conventional strut. However, the heating strip of FIG. 16 can be incorporated into the insulated strut assembly of FIG. 15. As shown in FIGS. 15 and 16, the strut indicated at 150 comprises a body member 151 having a connector member 152 at one end, and a plunger member or rod 153 having a connector member 154 reciprocally mounted in body member 151, and which is sealed in member 151 as known in the art. The body member 151/rod 153 may be provided with a conventional fluid or air arrangement which allows the rod 153 to be moved in or retained in the body member 151. In FIG. 15, the body member 151 is provided with a layer 155 of insulation material and a protective layer or sleeve 156 about the insulation layer. However, depending on the composition of the insulation layer 155, the protective sleeve or layer 156 may not be needed. In FIG. 16, which is constructed as in FIG. 15, the body member 151 is additionally provided with one or more electrical heating strips 157 (only one shown), which would be electrically connected by electrical leads 158 via, a thermostat 158′ to the power supply 159 of the vehicle on which the strut is utilized. The electrical heating strip(s) 157 is positioned between the body member 151 and the insulation layer 155, whereby a heated/insulated strut is provided to withstand either extremely high or extremely low temperatures. However, the body member 151 may be provided with one or more heating strips, if desired.

The hidden storage system is constructed such that a variety of storage shelves and/or storage compartments may be positioned in the storage boxes on either side of the bed. The storage boxes are provided with means by which shelves or compartments may be installed to fit a user's needs. The storage boxes may include areas of sufficient length and height for the storage of skis, ski poles, ski boots, and ski clothing, or for the storage of golf club bags and associated equipment or clothing, as well as for various tools, parts, etc. Also, the storage boxes may be designed to include areas for the storage of shopping purchases whereby such are secured from view—a truck with a trunk.

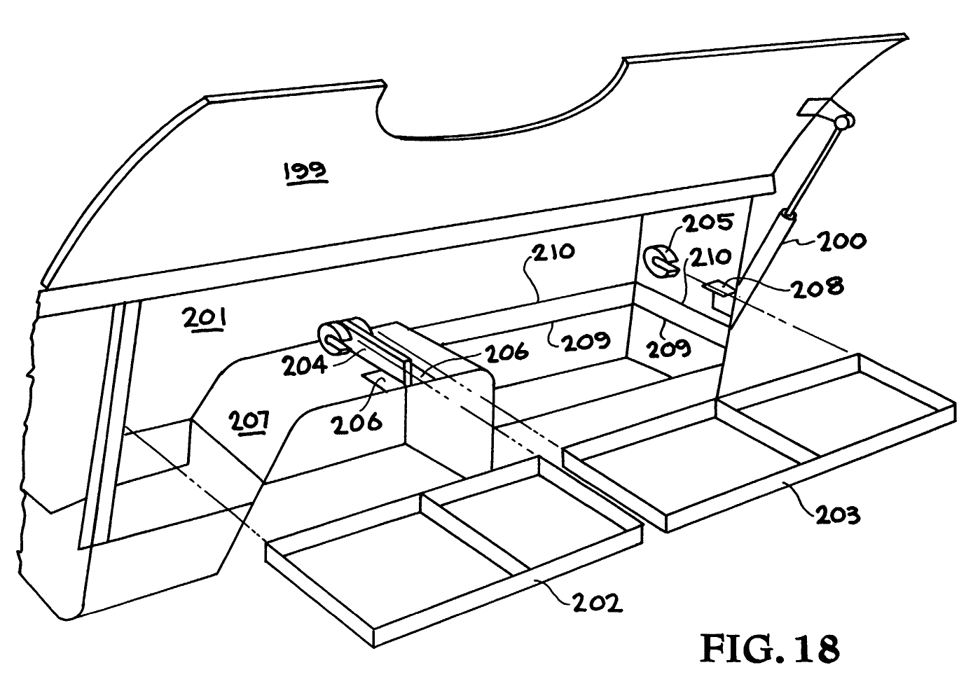

FIG. 17 schematically illustrates a shelf/storage compartment arrangement for tools, parts, etc. The shelves and storage compartments may be mounted so as to be movable (slideable) or adjustable. As shown in FIG. 17, a storage box such as illustrated at 51 in FIG. 5, for example, here generally indicated at 170, and which includes a wheel well section 171, is provided with different size and/or length shelves 172, 173, 174, 175, 176 and 177. The storage box 170 is provided with upwardly extending lips or members 178 and 179 which form open boxes or compartments 180 and 181. However, the storage box 170 may be constructed to provide a flat surface at the bottom by elimination of the upwardly extending members 178 and 179. The storage box 170 of FIG. 17 additionally includes six compartments or drawers, indicated at 182, for small parts, etc. Compartments 180 and 181 are provided with openings 183 in which are positioned drain/air relief valve assemblies 184, described in detail hereinafter with respect to FIG. 19. It is understood that the shelf/storage compartment arrangement of FIG. 17 can be incorporated into any of the vehicles of FIGS. 1-8 and 23-27.

One of the side panels of a vehicle of any of FIGS. 1-8 and 24-27, for example, is shown in detail in FIG. 18 wherein a side panel 199 is illustrated in an open position and retained by a gas lift or strut assembly 200 (only one shown) which may be constructed as shown in FIGS. 15 and 16. As seen in FIG. 18, the side panel assembly 195 additionally includes a storage box 201 into which are slideably mounted shelves or box shelves 202 and 203, which are supported by a common support member 204 and include flange sections, not shown, which extend into slots in member 24 and in a pair of end support members 205 (only one shown). The adjacent or inner ends of slideable shelves 202 and 203 slide on members 206 secured to the wheel well 207, while the outer or opposite ends of shelves 202 and 203 slide on member 208 (only one shown) secured to ends of the storage box 201. The storage box 201 is additionally provided with shelf supports 209 and 210 on which a shelf, not shown, can be mounted whereby the height thereof can be adjusted for various uses. If desired, support members similar to member 205 can be located at 209 or 210 to enable the uses of additional sliding shelves. Also, vertical adjustable shelf supports may be utilized. It is understood that the shelf arrangement of FIG. 18 can also be incorporated into the vehicles of FIGS. 1-8 and 24-27.

FIG. 19 illustrates an embodiment of a drain/air relief valve assembly indicated generally at 184 in FIG. 17 which is mounted in an opening 183 in compartments 180 and 181 of storage box 170. The valve assembly 184 is mounted in opening 183 of compartment 180, for example, by a tub or member 185 having an opening 186 and is secured in opening 183 at the outer periphery thereof, and may be constructed of metal, a composite, or plastic, for example. Valve assembly 184 includes a housing 187 or body members 188 and 189 secured together as by a threaded connection, not shown, with lower body member 188 having a groove 190 therein into which tub 185 extends, whereby the housing 187 is retained in opening 186 of tub 185. The housing 187 may be constructed of EPDM or rubber, for example. Body members 188 and 189 are provided with aligned openings 191 and 192, with a plug or member 193 having a pull grip 194 extending into opening 192. Opening 191 in lower body member 188 is provided a valve 195 having a flexible member 196 while upper body member 189 is provided with a plurality of radially extending openings 197. Flexible member 196 may be constructed of rubber, for example. Upon raising the plug 193 via the pull grip 194, water and/or air within compartment 180 of storage box 170 flows through radial openings 197 and moves downwardly (opens) flexible member 196 of valve 195, as illustrated by flow arrows 198. With the plug 193 in place, as shown in FIG. 19, air or moisture will not pass upwardly due to seating of flexible member 196 of valve 195.

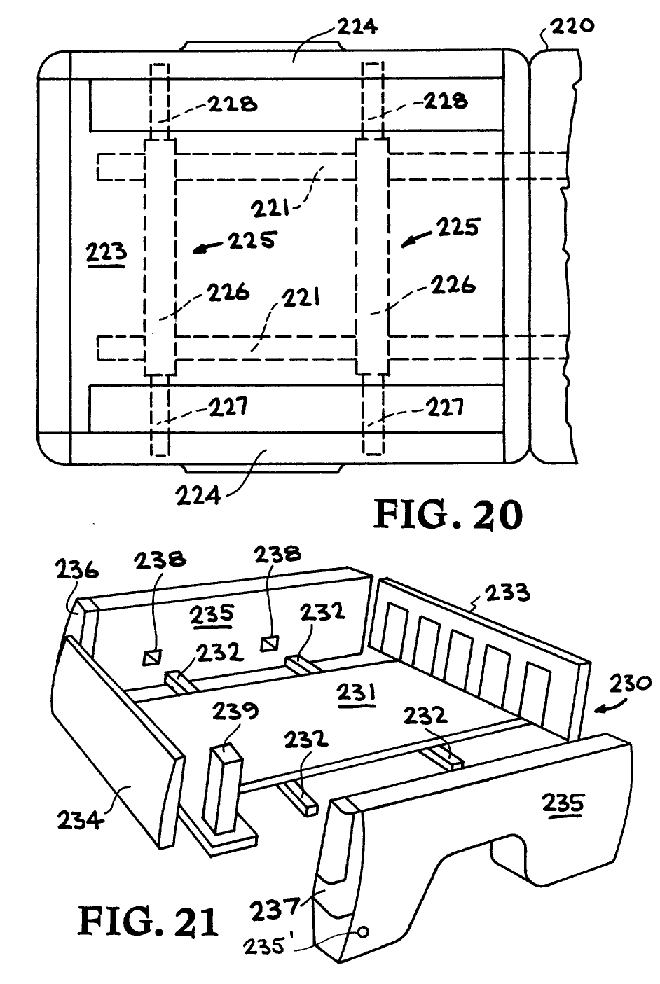

The hidden storage system, as illustrated in FIGS. 1-2 and 8, for example, may be provided with support/safety mechanisms, as illustrated in FIGS. 20 and 21, which comprise a pair of collapsible beams. Upon impact from a side of the storage system, the beams collapse rather than bending, thereby preventing rupture or puncture of a fuel tank, typically located beneath the bed of a pickup truck.

As seen in FIGS. 20 and 21, a vehicle 220, such as a pickup truck, having frame members 221, wheels 222 (only one shown) mounted on an axle, not shown, is provided with a hidden storage bed 223 having side panel/fenders 224, such as seen in FIGS. 1-2. A pair of collapsible support beams 225 are mounted across the frame members 221 and extend outwardly so as to terminate inside the side panel/fenders 224. As seen in FIG. 20, each of the collapsible support beams 225 is composed of a central section 226 and end sections 227 and 228 that are constructed to extend into central section 228. Beams 225 may be square, rectangular, circular, etc. in configuration. The length of the central section 226 and the length of end sections 227 and 228 is determined by the width of the bed 223. The end sections 227 and 228 may be spot welded, for example, at a desired point to central section 226, and upon impact the spot weld is broken, and the impacted end section collapses into the central section 226 which prevents the bed 223 from bending downward toward the fuel tank located beneath the bed.

FIG. 21 illustrates a modular assembly approach for the hidden storage bed of FIG. 20 utilizing the collapsible support members or beams. As shown schematically in FIG. 21, the bed generally indicated at 230 is basically composed of five modules or assemblies comprising a floor assembly 231 to which collapsible support beams 232 are mounted or connected, a bulkhead assembly 233, a tailgate assembly 234, and a pair of side panel assemblies 235 having connected thereto tail light assemblies 236 and 237, respectively. Side panel assemblies 235 are provided with openings 238 into which collapsible support beams 232 extend. Floor assembly 231 includes a pair of support posts 239, only one shown, to which the rear of side panel assemblies 235 are secured. The side panel assemblies 235 may be constructed as illustrated in FIG. 18, for example, or constructed to include a plurality of hinged side panel sections, as illustrated in FIG. 8, wherein the tail light assemblies are hinged to open with the side panel. If desired, an optional key entry or slot 235′ may be incorporated into side panel assemblies 235 to release the side panel.

In cold weather conditions, the hinged side panels of the hidden storage system, like doors and trunk lids of vehicles, freeze to the seals located about the periphery of the compartment openings, and FIGS. 22, 23 and 28 illustrate heated seal arrangements to eliminate this frosty problem. FIG. 22 illustrates a cross-section of an embodiment of a heated seal assembly generally indicated at 240 secured to a flange 241 of a compartment structure and includes a bulb or compression section 242 and a flange attachment or gripping section 243, the bulb or compression section 242 is adapted to abut a compartment lid or hinged panel section, not shown. Section 243 is of an elongated U-shaped configuration defining an opening 244 in which a flexible U-shaped heating element 245 is located and which includes inwardly extending curved flanges 246 which abut insulation layers 247 and function to secure the seal assembly 240 to the flange 241. A flexible U-shaped electrical connector or clip 248 has an insulating layer 248′, and having inwardly extending contacts or prongs 249 which penetrate the gripper section 243 to connect the heating element 245 to a power supply, not shown, but similar to that of FIG. 23. The clip or connector may be of a multi-prong type.

FIG. 23 illustrates a heated seal assembly, such as illustrated in FIG. 22, which utilizes a pair of interconnected seal members, connected to a power supply/controller via electrical contact clips, such as clip 248 of FIG. 22. While FIG. 23 illustrates two seal assemblies 250 and 251 interconnected end to end by a connector or clip 252, any number of seal assemblies may be utilized. In the FIG. 23 arrangement, each of seal assemblies 250 and 251 terminate in a connector or clip 253 and 254, respectively, which may also be constructed as clip 248 in FIG. 22, and which are connected by electrical leads 255 and 256 to an adapter 257, by which either an alternating current (AC) or a direct current (DC) power supply may be connected via a thermostat, timer, switch, or combination to a power source or supply, all indicated generally at 258 and connected electrically via electrical lead 259 and 259′ to adaptor 257. Since those skilled in the electrical field have a working understanding of how a simple switch or a thermostat or a thermostatically controlled switch and/or timer can be interconnected between either a DC power supply, such as the vehicle battery, or an auxiliary battery and the adaptor 257, or between an AC power supply located on or off the vehicle and the adaptor 257, description or illustration of a detailed electrical system is deemed unnecessary. The seal assembly heating arrangement may be such so as to heat the seal or seals for a period of time prior to use of the vehicle to thaw any frost which may have accumulated on the seal assemblies, or under extreme cold conditions the seal assemblies may be continuously heated to prevent freezing of the hinged side panel sections to the seal assemblies.

FIG. 24 is a side view of a truck type emergency vehicle having a cab with an enclosed bed mounted on the vehicle freeze behind the cab, and with a hidden storage system mounted in one or both sides of the enclosed bed. As shown, the emergency vehicle includes a cab 260 and enclosed bed 261 having wheel wells 262, only one shown. The hidden storage system, like those described and illustrated in FIGS. 1-8, for example, include a storage box mounted adjacent on one or both sides of the bed or body, or more hinged side panel sections to provide access to the interior of the storage box, and a lock/latch mechanism for the hinged one or more side panel sections. The height and width of the storage box(s) is dependent on the individual application and thus may vary according to the vehicle on which the storage box(s) are located. Also, the storage boxes may include sections located fore and aft of the wheel wells as well as above the wheel wells, or may merely extend horizontally along a line above the wheel wells. As shown in FIG. 24, the hidden storage system includes a hinged side panel section indicated at 263 which is located fore, aft and above the wheel well 262 and extends the length of the side panel of the enclosed bed 261. The side panel section 263 is hinged horizontally at an upper edge 264 so that it can be raised to provide access to a storage box therebehind, with the lower edge 265 extending along a floor or frame member 266. The hinged side panel section 263 is provided with strut assembly, such as shown in FIGS. 15 and 16 for maintaining the panel section 263 in an open position. In this embodiment the storage box may have a height extending from the floor of the enclosed bed 261 to at or above the upper edge 264 of hinged side panel section 263, or having a height from the top of wheel well 262 to at or above the upper edge 264 of panel section 263. Also, the hinged side panel section may also be located above the wheel well with the lower edge being indicated by dash line 265′. In view of the length of the hinged side panel section 263, it may be preferable to utilize a plurality of hinged sections as illustrated in FIGS. 8-12. For example, the hinged side panel section can be cut along the dash line 265 or down the dash lines 268 and 269 to divide the section 263 into either two or three hinged sections. The one or more hinged side panel sections may utilize a lock/latch arrangement as illustrated in FIGS. 13 and 14, for example. If desired, optional key entries indicated at 263′ may be utilized to release the side panel 263. Also, the storage box may include one or more drain/air plug assemblies as illustrated in FIGS. 17 and 19, as well as shelving/compartment as illustrated in FIGS. 17 and 18, for example. As seen in FIG. 24, the only external difference in appearance are the two horizontal cut lines that define the upper and lower edges of the hinged side.

FIG. 25 is a side view of a conventional commercial van having only driver and passenger doors, and are utilized for various commercial applications as well as emergency vehicles. The van of FIG. 25 includes a hidden storage system similar to that described above with respect to FIG. 24, wherein the hinged side panel section is located above the wheel well, and extends from adjacent one or both of the doors to the rear end of the vehicle, and includes the tail light assembly. As shown, the van generally indicated at 270 includes a cab section 271 and a body section 272, with the cab section 271 including a drivers side door 273, and with the body section including a wheel well 274 and a tail light assembly 275. The hidden storage system includes a hinged side panel section 276 which is horizontally hinged at an upper edge 277 and includes a forward edge 278 adjacent door 273 and lower edge 279, such that the side panel section 276 is raised to expose the interior of the storage box mounted within the body section 272 on one or both sides thereof. As in FIG. 24, the hinged side panel section 276 can be located above the wheel well 274, and the storage box may extend from the floor of the body section 272, fore, aft and over wheel well 274 to or above the upper edge 277 of the hinged side panel section 276, or may extend upwardly from the top of wheel well 274 as described above with respect to FIG. 24. If desired, an optional key entry indicated at 276′ can be installed to release the side panel 276. In FIG. 25, the tail light assembly 275 is designed to be raised and lowered with hinged side panel section 276, as described with respect to FIG. 8 and FIG. 27. The only change in the external appearance of the van 270 is the cut lines defining the hinged side panel section 276, with the external contour of the body section 272 of van 270 being the same as an identical van without the hidden storage system. If desired, the hinged side panel section 276 can extend to the lower edge of the side panel as indicated by dash line 279′, which extends around the wheel well 274. Also, the panel section 276 may be divided as indicated by dash line 279″.

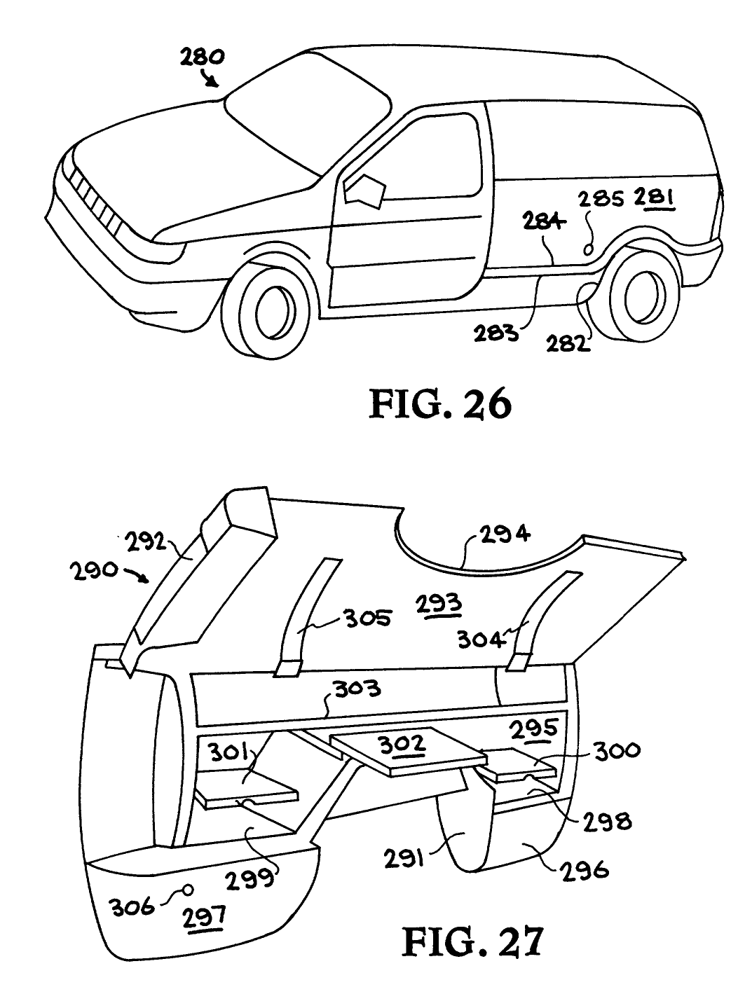

FIG. 26 illustrates a side view of a vehicle similar to FIG. 5, but differs in the configuration of the hinged side panel section. As shown in FIG. 26, the van generally indicated at 280, such as a Dodge Caravan, can be either initially assembled or modified (retrofitted) to include a storage box located behind a hinged side panel section 281, with the storage box and hinged side panel section being configured to extend over a wheel well 282 of van 280. The storage box may be provided with at least one shelf which may be of an adjustable type and/or slideable type, as shown in FIGS. 17 and 18. A seal assembly, such as illustrated in FIGS. 22 and 23, is utilized to seal out moisture and/or dust when hinged side panel section 281 is closed. If desired, an optional key entry indicated at 285 may be installed to release the side panel 281. Also, a strut assembly, such as shown in FIGS. 15 and 16, may be utilized to retain the hinged side panel section 281 in open position. The primary difference between FIG. 26 and FIG. 5 is the location of the lower edge of the hinged side panel section. The FIG. 26 embodiment includes a decorative strip 283 located above wheel well 282 and along the side panel of the van, and a lower edge 284 of the hinged side panel section 281 extends adjacent the decorative strip 283, such that when panel section 281 is raised the decorative strip 283 remains over the wheel well 282 and along the side panel. The hinged side panel section 281 may be modified as described above to include a plurality of hinged sections which may be hinged to be raised or lowered when opened to expose the interior of the storage box within the van 280. The van 280 may include a hidden storage system on both sides thereof.

FIG. 27 illustrates a side view of a hidden storage system mounted in one or both side panels of a vehicle, such as a pickup or a van, as illustrates in FIGS. 1-8. If mounted in the side panel of a pickup, for example, the pickup bed may be constructed as a modular assembly, such as illustrated in FIG. 21, with or without the collapsible support members of FIGS. 20 and 21. The side panel of FIG. 27, indicated generally at 290, includes a wheel well 291 and a tail light assembly 292 which is secured to a hinged side panel section 293. The hinged side panel section 293 includes a cut away section 294 that corresponds to and cooperates with the wheel well 291. The side panel 290 includes a storage box 295 which extends over, and fore and aft of wheel well 291, and with the fore and aft sections of unhinged sections 296 and 297 defining bins 298 and 299 having hinged lids 300 and 301. The remainder of the storage box provides a space above the bins 298 and 299 and above the wheel well 291 in which shelves or compartments may be installed, such as illustrated in FIGS. 17 and 18. As shown in FIG. 27, a sliding shelf 302 is mounted above the wheel well 291, and which may serve as a work top, and a shelf 303 extends along the length of the storage box 295, and which may be of an adjustable type as shown in FIG. 18. The hinged side panel section 293 is retained open by spring type hinge assemblies indicated at 304 and 305, but strut assemblies, such as illustrated in FIGS. 15 and 16 may be utilized with one or more horizontally extending hinges along an upper edge of the side panel section 293. While not shown, each of the bins 298 and 299 may be provided with a drain/air relief valve assembly, as illustrated in FIGS. 17 and 19. Also, a seal assembly, not shown, would be located adjacent the periphery of the hinged side panel section 293 when closed, and may be of a heated tone as illustrated in FIGS. 22 and 23. If desired, an optional key entree indicated at 306 may be installed to release side panel section 293. As shown, the hinged side panel section 293 extends from the forward lip or end of the side panel 290 to the rear end of the bed and includes the tail light section 292, which is electrically connected by an electrical harness, not shown, which allows the tail light section 292 to move with hinged side panel section 293. The side panel 290 and wheel well 291 may include a decorative strip, such as illustrated in FIG. 26, and that decorative strip may be constructed to be attached to and move with hinged side panel section 293, or be attached to the wheel well 291 and the fore and aft side panels 296 and 297. If desired, the hinged side panel section 293 may be divided into a plurality of hinged sections, such as shown in FIG. 8, and such that any one of the hinged sections may be hinged to move upward, downward, or sideways.

FIG. 28 illustrates another embodiment of a heated anti-icing seal assembly. The seal assembly generally indicated at 350 is mounted intermediate a compartment body structure 351 and a compartment lid or hinged panel section 352 by an adhesive mounting strip 353. The seal assembly 350 includes a bulb or compression section 354 integral with a body section 355 attached to the mounting strip 353. Within the bulb section 354 are a reflective shield 356 and a heating element 357, with an electrical wire 358 extending from the heating element 357 through the reflective shield 356 and through the body section 355 of seal assembly 350 for connection to a controller/power supply or source 359, such as described above with respect to FIG. 23. It is understood that a single seal assembly 350 may extend entirely around a compartment opening as in FIG. 1, or the overall seal assembly extending around the compartment may be composed of a number of interconnected sections or lengths, each being electrically connected as in FIG. 23. However, a single seal assembly requires less electrical connections and thus is preferred, it being recognized that for very large openings a single seal assembly may be less efficient than a plurality of similarly connected seal assemblies.

While specific embodiments of the hidden storage system in accordance with the present invention have been described and/or illustrated, such are not intended to be limiting. For certain vehicles, such as the conventional three-door van, only one side of the vehicle would incorporate a hidden storage arrangement, while other vehicles may include a hidden storage on both sides. The length, depth and height of the storage box or boxes and the associated hinged side panel section(s) may vary with the configuration of the vehicle (two door or four door), and if it has windows along the side. Also, the hinged side panel section may or may not include the fender of the vehicle. In addition, depending on the intended use of the vehicle, two or more hinged side panel sections may be used with single or plural storage boxes. Thus it has been shown that the present invention provides hidden storage for vehicles, particularly vans and emergency/utility/sports utility vehicles, with only very minor alteration of the external appearance of the vehicle, the only alteration being cut lines defining the edges of the hinged side panel sections. By elimination of the exposed lock/latch mechanism, the potential for theft is greatly reduced. However, the hinged compartment covers or side panel could be provided with a key slot only, but such would increase the potential for theft.

The vehicle can be modified to incorporate the hidden storage, a conversion method, or the hidden storage can be incorporated via an assembly line manufacture of the vehicle or installed utilizing a modular assembly approach. Modifications and changes may become apparent to those skilled in the art, and it is intended that the invention be limited only the scope of the appended claims.

What is claimed is:

1. A vehicle having side panels with inner and outer panel portions, and a hidden storage system which does not substantially alter an external appearance of said side panels when compared to side panels of a substantially identical vehicle without a hidden storage system, said hidden storage system including:
at least one storage box, having an interior and an opening along one side thereof, mounted within said vehicle such that said opening is adjacent one of said side panels;
at least one section of said one of said side panels having said inner panel portion removed at least in an area adjacent said opening in said at least one storage box, said at least one section of said one of said side panels having said outer panel portion hinged at least in said area adjacent said opening in said at least one storage box;
whereby an outward movement of said at least one hinged outer panel portion provides access to said interior of said storage box, and
means for securing said at least one hinged outer panel portion to prevent access to said interior of said storage box.

2. The vehicle of claim 1, additionally including wheel wells, and wherein said at least one hinged outer panel portion is located along a length of said one of said side panels and at a height greater than a height of said wheel wells.

3. The vehicle of claim 2, wherein said at least one storage box mounted within said vehicle is composed of sections so as to be located above, forward of, and rearward of at least one of said wheel wells,
whereby outward movement of said at least one hinged outer panel portion enables access to said interior of at least one of said sections of said storage box.

4. The vehicle of claim 2, wherein said at least storage box and said at least one hinged outer panel portion extend substantially a length of said one of said side panels.

5. The vehicle of claim 1, wherein said means for securing said at least one hinged outer panel portion comprising a lock/latch mechanism which can be activated mechanically or electrically.

6. The vehicle of claim 5, wherein said lock/latch mechanism is activated electrically and includes a remote actuator means.

7. The vehicle of claim 1, selected from the group consisting of vans, minivans, utility vehicles, sports utility vehicles, and emergency vehicles.

8. The vehicle of claim 7, comprising an emergency vehicle consisting of a cab section and a bed section, and wherein said hidden storage system is mounted in said bed section.

9. The vehicle of claim 7, having a single body with at least a driver's side door and a rear end, and wherein said hidden storage system is mounted in said body intermediate said side door and said rear end.

10. The vehicle of claim 7, having a single body with at least a door on each side and a rear end, and wherein said hidden storage system is mounted on each side of said vehicle intermediate a rearmost door and said rear end.

11. The vehicle of claim 1, selected from the group consisting of trucks, pickups and trailers, each including a bed, and wherein said hidden storage system is mounted in said bed.

12. The vehicle of claim 11, wherein said at least one storage box of said hidden storage system has a height less than a height of said bed.

13. The vehicle of claim 11, wherein said at least one storage box of said hidden storage system has a length less than a length of said bed.

14. The vehicle of claim 11, comprising a pickup with said bed including a bulkhead section, said side panels, a tail light section, and a tail gate section, and wherein said hinged outer panel portion of said side panel is operatively connected to said tail light section,
whereby outer movement of said hinged outer panel portion moves said tail light section therewith.

15. The vehicle of claim 1, additionally including a seal assembly mounted to be in contact with said hinged outer panel portion.

16. The vehicle of claim 15, wherein said seal assembly includes means for heating said seal assembly.

17. The vehicle of claim 16, wherein said means for heating comprises an electrical power supply, an electrical heating element within said seal assembly, and means for controlling electrical power to said heating element.

18. The vehicle of claim 1, additionally including at least one strut assembly operatively corrected to said at least one hinged ouster panel portion.

19. The vehicle of claim 18, wherein said at least one strut assembly includes means for at least heating said strut assembly.

20. The vehicle of claim 1, wherein said at least one storage box includes at last one means located in said storage box and selected from the group consisting of at least one shelf, at least one compartment at least one adjustable shelf, at least one slideable shelf, and at least one movable shelf.

21. The vehicle of claim 1, wherein said at least one storage box includes at least one drain/air relief valve assembly located in a bottom area of said storage box.

22. The vehicle of claim 1, wherein a hidden storage system is mounted on each side of said vehicle, and accessible only through a hinged outer panel portion in each of said side panels.

23. The vehicle of claim 1, wherein said means for securing said at least one hinged outer panel portion comprises an unexposed lock and latch mechanism.

24. The vehicle of claim 1, wherein said hidden storage system includes a plurality of hinged outer panel portions, each of said plurality of hinged outer panel portions being hinged to provide access to a portion of said interior of said at least one storage box.

25. The vehicle of claim 24, additionally including at least one outer panel portion of said at least one side panel which is constructed to be slideable with respect to said one side panel, and connected to a slideable compartment of said storage box.

26. The vehicle of claim 24, wherein said plurality of hinged outer panel portions comprises at least three hinged outer panel portions, each of said hinged outer panel portions being hinged to move upwardly, downwardly, or sideways.

27. The vehicle of claim 1, wherein said at least one hinged panel portion has a length substantially equal to a length of said at least one side panel, said hinged side panel portion being horizontally hinged at an upper edge portion thereof.

28. The vehicle of claim 1, additionally including at least one strut assembly for retaining said hinged side panel portion in an open position.

29. The vehicle of claim 1, wherein said vehicle includes a bed, and additionally including a collapsible support system for said bed.

30. In a vehicle having contoured side panels, the improvement comprising a hidden storage system mounted on each side of said vehicle and adjacent said contoured side panels, each hidden storage system including:
a storage box within said vehicle secured at least to said contoured side panel and having an interior;
at least one section of said contoured side panel adjacent said storage box being hinged to enable access to said interior of said storage box; and
a hidden lock/latch mechanism for said at least one hinged section of said contoured side panel,
whereby when said hinged side panel section is in a closed position to prevent access to said interior of said storage box, an external appearance of said contoured side panel is substantially the same as a substantially identical contoured side panel of vehicle without a hidden storage system mounted therein.

31. The hidden storage system of claim 30, wherein said at least one hinged side panel section extends along a length substantially equal to a length of said contoured side panel.

32. The hidden storage system of claim 30, wherein said at least one hinged side panel section is horizontally hinged.

33. The hidden storage system of claim 30, wherein hidden lock/latch mechanism is constructed to be mechanically or electrically controlled.

34. The hidden storage system of claim 30, additionally including at least another hinged side panel section, each of said hinged side panel sections being hinged horizontally or vertically.

35. The vehicle of claim 30, additionally including wheel wells, and wherein each of said hidden storage systems have a storage box which extends over, forward of, and rearward of said wheel wells.

36. The vehicle of claim 35, wherein at least one of said hinged side panel sections is located at a height above a height of an associated wheel well and extends horizontally forward of and rearward of said associated wheel well.

37. The vehicle of claim 36, wherein said at least one of said hinged side panel sections has a length which extends substantially a length of said contoured side panel in which it is hinged.

38. The vehicle of claim 35, wherein each of said hidden storage systems includes a plurality of hinged side panel sections, each hinged side panel section being hinged to either open upwardly, downwardly, or sideways.

39. The vehicle of claim 30, wherein said improvement is located in a bed of said vehicle, and additionally including collapsible support beams for said bed.

40. The vehicle of claim 1, additionally including:
a seal assembly, mounted to be in contact with said hinged outer panel portion, said seal assembly being constructed to be electrically heated;
at least one means operatively connected to said at least one hinged outer panel portion for maintaining said hinged side panel portion in an open position;
at least one drain/air relief valve assembly located in a bottom area of said storage box; and
a collapsible support system located under a floor section of said vehicle.
